(19) United States
(12) Patent Application Publication
(10) Pub. No.: US 2014/0260230 A1
(43) Pub. Date: Sep. 18, 2014

(54) HORIZONTAL ACTUATION COMPRESSED AIR ENERGY STORAGE SYSTEM

(71) Applicant: General Compression, Inc., Newton, MA (US)

(72) Inventors: Bryce Richards, Ann Arbor, MI (US); Kenneth Kernyo, Carleton, MI (US); Ryan Heinbuch, Plymouth, MI (US)

(21) Appl. No.: 14/213,045

(22) Filed: Mar. 14, 2014

Related U.S. Application Data
(60) Provisional application No. 61/792,872, filed on Mar. 15, 2013.
(60) Provisional application No. 61/792,880, filed on Mar. 15, 2013.

(51) Int. Cl. F15B 3/00

(52) U.S. Cl. CPC F15B 3/00
USPC 60/327; 60/408

(57) ABSTRACT

A modular compressed air energy storage system includes modular low pressure and high pressure subsystems coupled together with interstage pipes. Each of the subsystems includes a hydraulic vessel adapted to contain a heat transfer liquid and having a piston disposed therein for horizontal reciprocating movement. First and second pressure vessels are coupled to the hydraulic vessel on opposite sides of the piston, each adapted to contain the heat transfer liquid and/or a gas. First and second heat transfer devices are respectively disposed within upper regions of the pressure vessels. The piston is moveable in a first direction to displace at least some of the heat transfer liquid from the hydraulic vessel to the first pressure vessel and is moveable in a second direction to displace at least some of the heat transfer liquid from the hydraulic vessel to the second pressure vessel.

### CROSS-REFERENCE TO RELATED APPLICATION

This application claims priority to and the benefit of U.S. Provisional Patent Application No. 61/792,880, filed Mar. 15, 2013, and entitled “Horizontal Actuation Compressed Air Energy Storage System,” and U.S. Provisional Patent Application 61/792,872, filed Mar. 15, 2013, and entitled “Horizontal Actuator for a Compressed Air Energy Storage System,” the entireties of which are hereby incorporated by reference herein.

### FIELD OF THE INVENTION

The invention relates generally to a gas compression and/or expansion system and, more particularly, to a modular compressed air energy storage system having modular low pressure and high pressure subsystems coupled together with interstage pipes.

### BACKGROUND

Traditionally, electric power plants have been sized to accommodate peak power demand. Moreover, electric power plant sizing must take into account their maximum power output, minimum power output, and a middle power output range within which they most efficiently convert fuel into electricity. Electric power plants are also constrained in terms of how quickly they can start-up and shut-down, and it is commonly infeasible to completely shut-down a power plant. The combination of power output constraints and start-up and shut-down constraints restricts a power plant's ability to optimally meet a fluctuating power demand. These restrictions may lead to increased greenhouse gas emissions, increased overall fuel consumption, and/or to potentially higher operating costs, among other drawbacks. Augmenting a power plant with an energy storage system may create an ability to store power for later use, which may allow a power plant to fulfill fluctuating consumer demand in a fashion that minimizes these drawbacks.

An energy storage system may improve overall operating costs, reliability, and/or emissions profiles for electric power plants. Existing energy storage technologies, however, have drawbacks. By way of example, batteries, flywheels, capacitors and fuel cells may provide fast response times and may be helpful to compensate for temporary blackouts, but have limited energy storage capabilities and may be costly to implement. Installations of other larger capacity systems, such as pumped hydro systems, require particular geological formations that might not be available at all locations.

Intermittent electric power production sites, such as some wind farms, may have capacities that exceed transmission capabilities. Absent suitable energy storage systems, such intermittent power production sites may not be capable of operating at full capacity. Such intermittent production sites may benefit from a storage system that may be sized to store energy, when the production site is capable of producing energy at rates higher than may be transmitted. The energy that is stored may be released through the transmission lines when power produced by the intermittent site is lower than transmission line capacity.

Likewise, electric power consumption sites, such as buildings, towns, cities, commercial facilities, and military facilities, may have consumption that periodically exceeds electricity transmission capabilities. Absent suitable energy storage systems, such power consumers may not be capable of operating at preferred levels. These transmission constrained consumption sites may benefit from a storage system that may be sized to store energy when the consumption site is consuming energy at rates lower than may be transmitted. The energy that is stored may be released to the consumers when power consumption of the consumers is higher than the transmission line capacity. The energy may also be stored during off-peak time periods (e.g., at night) when electricity prices are generally less expensive and released during peak time periods (e.g., during the day) when electricity prices are generally more expensive.

A compressed air energy storage (CAES) system is a type of system for storing energy in the form of compressed gas (e.g., air). CAES systems may be used to store energy in the form of compressed air when electricity demand is low, typically during the night, and then to release the energy when demand is high, typically during the day. Such systems include a compressor that operates, often at a constant speed, to compress air for storage. Turbines, separate from the compressor, are typically used to expand compressed air to produce electricity. Turbines, however, often require the compressed air to be provided at a relatively constant pressure, such as around 35 atmospheres. Additionally or alternatively, air at pressures higher than 35 atmospheres may need to be throttled prior to expansion in the turbine, causing losses that reduce the efficiency of the system and/or reduce the energy density that a storage structure may accommodate. Additionally, to increase electrical energy produced per unit of air expanded through the turbine, compressed air in such systems is often pre-heated to elevated temperatures (e.g., 1000° C) prior to expansion by burning fossil fuels that both increases the cost of energy from the system and produces emissions associated with the storage of energy.

Some existing CAES-type systems for storing energy as compressed air have a multi-stage compressor that may include intercoolers that cool air between stages of compression and/or after-coolers that cool air after compression. In such a system, however, the air may still achieve substantial temperature increases during each stage of compression, prior to being cooled, which introduce inefficiencies in the system. Accordingly, there is a need for systems and methods to obtain a high efficiency output of a compressed air energy storage system, or other systems used to compress and/or expand gas.

### SUMMARY

Various embodiments of a gas compression and/or expansion system and methods for operating the same are described. In one aspect, a modular compressed air energy storage system includes a modular low pressure subsystem that has a low pressure hydraulic vessel adapted to contain a heat transfer liquid. The low pressure hydraulic vessel includes a low pressure piston disposed therein for horizontal reciprocating movement. The low pressure subsystem further includes first and second low pressure vessels coupled to the low pressure hydraulic vessel on opposite sides of the low pressure piston, each adapted to contain at least one of the heat transfer liquid and a gas, and first and second heat transfer devices respectively disposed within upper regions of the first and second low pressure vessels. The low pressure piston is moveable in a first direction to displace at least some of the heat transfer liquid from the low pressure hydraulic vessel to the first low pressure vessel, and in a second direction to displace at least some of the heat transfer liquid from the low pressure hydraulic vessel to the second low pressure vessel.

In one embodiment, each of the first and second heat transfer devices is adapted to transfer heat energy between the gas and the heat transfer liquid by contacting a surface of the heat transfer device with the heat transfer liquid. The low pressure piston can be moveable to alternatively compress gas in each of the first and second low pressure vessels, as well as to alternatively expand gas in each of the first and second low pressure vessels.

In another embodiment, the system further includes a modular high pressure subsystem that has a high pressure hydraulic vessel adapted to contain a heat transfer liquid. The high pressure hydraulic vessel includes a high pressure piston disposed therein for horizontal reciprocating movement. The high pressure subsystem further includes first and second high pressure vessels coupled to the high pressure hydraulic vessel on opposite sides of the high pressure piston, each adapted to contain at least one of the heat transfer liquid and a gas, and third and fourth heat transfer devices respectively disposed within upper regions of the first and second high pressure vessels. The high pressure piston is moveable in a first direction to displace at least some of the heat transfer liquid from the high pressure hydraulic vessel to the first high pressure vessel, and in a second direction to displace at least some of the heat transfer liquid from the high pressure hydraulic vessel to the second high pressure vessel. The first high pressure vessel is fluidically coupled to the first low pressure vessel via a first interstage pipe, and the second high pressure vessel is fluidically coupled to the second low pressure vessel via a second interstage pipe.

In one embodiment, each of the third and fourth heat transfer devices is adapted to transfer heat energy between the gas and the heat transfer liquid by contacting a surface of the heat transfer device with the heat transfer liquid. The high pressure piston can be moveable to alternatively compress gas in each of the first and second high pressure vessels, as well as to alternatively expand gas in each of the first and second high pressure vessels.

In a further embodiment, each interstage pipe includes a first valve coupling a high pressure vessel and storage, a second valve coupling a low pressure vessel and ambient, and a third valve coupling a high pressure vessel and a low pressure vessel.

In one implementation, the system includes a first hydraulic actuator coupled to the low pressure piston, and a second hydraulic actuator coupled to the high pressure piston. The system can further include a second low pressure subsystem and a second high pressure subsystem, with the first hydraulic actuator further coupled to a high pressure piston of the second high pressure subsystem, and the second hydraulic actuator further coupled to a low pressure piston of the second low pressure subsystem.

In yet another embodiment, the system is duplicated one or more times, and each system is connected in parallel by low pressure and high pressure gas lines fluidically coupled to the respective interstage pipes of each system. One or both of the low pressure subsystem and the high pressure subsystem can be configured substantially symmetrically.

In another aspect, a method for operating a modular compressed air energy storage system includes providing a modular low pressure subsystem. The low pressure subsystem includes a low pressure hydraulic vessel adapted to contain a heat transfer liquid and having a low pressure piston disposed therein for horizontal reciprocating movement. The subsystem further includes first and second low pressure vessels coupled to the low pressure hydraulic vessel on opposite sides of the low pressure piston, each adapted to contain at least one of the heat transfer liquid and a gas, and first and second heat transfer devices respectively disposed within upper regions of the first and second low pressure vessels. The low pressure piston is moved in a first direction to displace at least some of the heat transfer liquid from the low pressure hydraulic vessel to the first low pressure vessel, and in a second direction to displace at least some of the heat transfer liquid from the low pressure hydraulic vessel to the second low pressure vessel.

In one embodiment, heat energy is transferred between the gas and the heat transfer liquid by contacting a surface of at least one of the first and second heat transfer devices with the heat transfer liquid. The low pressure piston can be moved to alternatively compress gas in each of the first and second low pressure vessels, and to alternatively expand gas in each of the first and second low pressure vessels.

In another embodiment, a modular high pressure subsystem is provided. The high pressure subsystem includes a high pressure hydraulic vessel adapted to contain a heat transfer liquid and having a high pressure piston disposed therein for horizontal reciprocating movement. The subsystem further includes first and second high pressure vessels coupled to the high pressure hydraulic vessel on opposite sides of the high pressure piston, each adapted to contain at least one of the heat transfer liquid and a gas. The first high pressure vessel is fluidically coupled to the first low pressure vessel via a first interstage pipe, and the second high pressure vessel is fluidically coupled to the second low pressure vessel via a second interstage pipe. The subsystem also includes third and fourth heat transfer devices respectively disposed within upper regions of the first and second high pressure vessels. The high pressure piston is moved in a first direction to displace at least some of the heat transfer liquid from the high pressure hydraulic vessel to the first high pressure vessel, and in a second direction to displace at least some of the heat transfer liquid from the high pressure hydraulic vessel to the second high pressure vessel.

In one implementation, heat energy is transferred between the gas and the heat transfer liquid by contacting a surface of at least one of the third and fourth heat transfer devices with the heat transfer liquid. The high pressure piston can be moved to alternatively compress gas in each of the first and second high pressure vessels, and to alternatively expand gas in each of the first and second high pressure vessels.

In yet another embodiment, a first hydraulic actuator is coupled to the low pressure piston, and a second hydraulic actuator is coupled to the high pressure piston.

In a further embodiment, a second low pressure subsystem and a second high pressure subsystem are provided. The first hydraulic actuator is coupled to a high pressure piston of the second high pressure subsystem, and the second hydraulic actuator is coupled to a low pressure piston of the second low pressure subsystem. The modular compressed air energy storage system can be duplicated one or more times, and the systems can be connected in parallel by low pressure and high pressure gas lines fluidically coupled to the respective interstage pipes of each system.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description, when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a diagram of an example energy storage and delivery system usable with the present invention.

FIG. 2 is a diagram of a gas compression and/or expansion system according to an embodiment of the invention.

FIG. 3 is a schematic perspective view of a full unit of a gas compression and/or expansion system according to an embodiment of the invention.

FIG. 4 is a schematic top view of the gas compression and/or expansion system of FIG. 3.

FIG. 5 is a schematic perspective view of a modular compressor/expander vessel subassembly.

FIG. 6 is a schematic side view of a modular low pressure vessel arrangement,

FIG. 7 is a schematic side view of a modular high pressure vessel arrangement.

FIG. 8 is schematic side view with partial interior view of a modular low pressure vessel arrangement.

FIG. 9 is a diagram of a low pressure vessel and heat transfer device.

FIG. 10 is a schematic perspective view of an interstage pipe assembly.

FIG. 11 is a schematic top view of a half-unit of a gas compression and/or expansion system according to an embodiment of the invention.

FIG. 12 is a schematic side view of the gas compression and/or expansion system of FIG. 11.

FIG. 13 is a schematic top view of three full unit gas compression and/or expansion systems connected in parallel.

FIG. 14 is a schematic perspective view of the connected gas compression and/or expansion systems of FIG. 13.

### DETAILED DESCRIPTION

Gas compression and/or expansion systems and methods for optimizing and efficiently operating such systems are disclosed herein. The compression and/or expansion systems described herein, referred to also as CAES systems, may perform similar operations (e.g., compression and/or expansion of gases) and include similar structure (e.g., heat transfer devices, heat transfer liquid exchange systems, actuators, pressure vessel and piston arrangements) to those disclosed in U.S. Pat. No. 8,359,857, issued Jan. 29, 2013, and entitled “Compressor and/or Expander Device”; U.S. patent application Ser. No. 13/347,144, filed Jan. 10, 2012, published as US/2012/0222424 A1 on Sep. 6, 2012, and entitled “Compressor and/or Expander Device”; and U.S. Pat. No. 8,522,538, issued Sep. 3, 2013, and entitled “Systems and Methods for Compressing and/or Expanding a Gas Utilizing a Bi-directional Piston and Hydraulic Actuator,” the entireties of which are hereby incorporated by reference herein.

The gas compression and/or expansion systems can include one or more working pistons, e.g., liquid or solid pistons, movably disposed within one or more cylinders to compress gas and/or allow gas to expand within a working chamber. One or more pistons may be bidirectional; e.g., a bidirectional, or double-acting, piston may be configured to compress gas both when moved in a first direction and when moved in a second direction opposite to the first direction. The gas compression and/or expansion systems may also include one or more pistons movably disposed within a cylinder and configured to displace liquid within a working chamber when moved in more than one direction. For example, a bidirectional piston may be configured to discharge liquid from a first working chamber and draw liquid into a second working chamber when moved in a first direction, and discharge liquid from the second working chamber and draw liquid into the first working chamber when moved in a second direction, opposite the first direction. As used herein the term “piston” is not limited to pistons of circular cross-section, hut can include pistons with a cross-section of a triangular, rectangular, or other multi-sided shape or of any non-circular contoured shape (e.g., oval). Further, the term “piston” may include any suitable form of piston, including a liquid piston or a solid piston, which may be constructed of any appropriate material. The gas compression and/or expansion systems may be configured for two or more stages of gas compression and/or expansion.

In some embodiments, a working piston within a gas compression and/or expansion system may be driven by or drive one or more actuators (e.g., hydraulic, pneumatic, electric, and/or mechanical actuators). The loads applied to the working piston(s) can be varied during a given cycle of the system. For example, in a hydraulic actuator, by applying hydraulic fluid pressure to different hydraulic pistons, and/or different surfaces of the piston(s) within the hydraulic actuator(s), the ratio of the net working surface area of the hydraulic actuator to the working surface area of the working piston acting on the gas and/or liquid in the working chamber can be varied and, therefore, the ratio of the hydraulic fluid pressure to the gas and/or fluid pressure in the working chamber can be varied during a given cycle or stroke of the system. In addition, the number of working pistons, working chambers and actuators can be varied as well as the number of piston area ratio changes within a given cycle.

In some embodiments, a hydraulic actuator includes multiple axially aligned, double-acting cylinders and associated valving, which enable a plurality of “gears” in each direction for compression and expansion, wherein a “gear” is defined by a ratio of the effective working ram area to the effective hydraulic ram area of the pressurized cylinder(s). Such a hydraulic actuator is described in U.S. patent application Ser. No. 61/792,872, filed Mar. 15, 2013, and entitled “Hydraulic Actuator for a Compressed Air Energy Storage System,” the entirety of which is hereby incorporated by reference herein.

The hydraulic actuator may be coupled to a hydraulic pump having operating ranges that can vary as a function of, for example, flow rate and pressure, among other parameters. Systems and methods of operating the hydraulic pumps/motors to allow them to function at an optimal efficiency throughout the stroke or cycle of the gas compression and/or expansion system are described in U.S. Pat. No. 8,161,741, issued Apr. 24, 2012, and entitled “Systems and Methods for Optimizing Efficiency of a Hydraulically Actuated System,” the entirety of which is hereby incorporated by reference herein.

In some embodiments, the systems described herein are configured for use only as a compressor. For example, in some embodiments, a compressor device described herein can be used as a compressor in a natural gas pipeline, a natural gas storage compressor, or any other industrial application that requires compression of a gas. In another example, a compressor device described herein can be used for compressing carbon dioxide. For example, carbon dioxide can be compressed in a process for use in enhanced oil recovery or for use in carbon sequestration. In another example, a compressor device described herein can be used for compressing air. For example, compressed air can be used in numerous applications which may include cleaning applications, motive applications, ventilation applications, air separation applications, and cooling applications, amongst others.

In some embodiments, the systems described herein are configured for use only as an expansion device. For example, an expansion device as described herein can be used to generate electricity. In some embodiments, an expansion device as described herein can be used in a natural gas transmission and distribution system. For example, at the intersection of a high pressure (e.g., 500 psi) transmission system and a low pressure (e.g., 50 psi) distribution system, energy can be captured where the pressure is stepped down from the high pressure to a low pressure. An expansion device as described herein can use the pressure drop to generate electricity. In other embodiments, an expansion device as described herein can be used in other gas systems to harness the energy from high to low pressure regulation.

The CAES systems described herein can be configured for use with any suitable compressed gas storage chamber, including, for example, an underground storage structure (e.g., a pressure compensated salt cavern, an excavated cavern, a series of excavated caverns, etc.). Examples of suitable storage structures are described in U.S. patent application Ser. No. 13/350,050, filed Jan. 13, 2012, and entitled “Compensated Compressed Gas Storage Systems”; and International Patent Application No. PCT/US2013/041576, filed May 17, 2013, and entitled “Excavated Underground Caverns for Fluid Storage,” the entireties of which are hereby incorporated by reference herein. The CAES systems may also be used with other types of storage including, but not limited to, tanks, underwater storage vessels, and the like.

The CAES systems may also be used for energy storage and generation as shown in FIG. 1. A power source 102 (e.g., a wind farm including a plurality of wind turbines) may be used to harvest and convert wind or other types of energy to electric power for delivery to a power routing subsystem 110 and conversion subsystem 112. It is to be appreciated that the system 100 may be used with electric sources other than wind farms, such as, for example, with the electric power grid or solar power sources. In some embodiments, the power source 102 is collocated with the CAES system. It should be noted, however, that the power source 102 may be distant from the CAES system, with power generated by the power source 102 being directed to the CAES system via a power grid or other means of transmission. The power routing subsystem 110 directs electrical power from the power source 102 to the power grid 124 or conversion subsystem 112, as well as between the power grid 124 and the conversion subsystem 112.

The conversion subsystem 112 converts the input electrical power from the wind turbines or other sources into compressed gas, which can be expanded by the conversion subsystem 112 at a later time period to access the energy previously stored. The conversion subsystem 112 may include an interconnected (in series or parallel) motor/generator, hydraulic pump/motor, hydraulic actuator and compressor/expander to assist in the energy conversion process. At a subsequent time, for example, when there is a relatively high demand for power on the power grid, or when power prices are high, compressed gas may be communicated from the storage subsystem 122 and expanded through a compressor/expander device in the conversion subsystem 112. Expansion of the compressed gas drives a generator to produce electric power for delivery to the power grid 124. In some embodiments, multiple conversion systems may operate in parallel to allow the CAES system to convert larger amounts of energy over fixed periods of time.

Referring now to FIG. 2, a multistage compression and/or expansion system 200 according to one embodiment utilizes a plurality of hydraulic actuators 202a, 202b, with each actuator 202a, 202b coupled on one end to a working piston 210a, 210b of a low pressure hydraulic working vessel 214a, 214b and on the opposite end to a working piston 220a, 220b of a high pressure hydraulic working vessel 224a, 224b. The low pressure hydraulic working vessels 214a, 214b and high pressure hydraulic working vessels 224a, 224b include horizontal double-acting water pumps, each including a working piston 210a, 210b, 220a, 220b that divides the working vessel 214a, 214b, 224a, 224b into two chambers, One or more liquid management systems 230 may be coupled to each working vessel 214a, 214b, 224a, 224b and/or other vessels to facilitate the transfer of heat transfer liquid to and from the chambers of the working vessels 214a, 214b, 224a, 224b. Each side of the water pump in the working vessels 214a, 214b, 224a, 224b supplies a liquid piston to a vertical compression and/or expansion pressure vessel 240a-240d, 250a-250d, each of which houses a heat transfer device 260a-260d, 264a-264d (e.g., a thermal capacitor).

Low pressure vessel 240a associated with hydraulic actuator 202a is fluidically connected by an interstage pipe assembly 280a to high pressure vessel 250a associated with hydraulic actuator 202b. Likewise, low pressure vessels 240h 240d are connected by respective interstage pipe assemblies 280b-280d to respective high pressure vessels 250b-250d. Each interstage pipe assembly 280a-280d includes an ambient valve (to selectively connect the low pressure chamber to the atmosphere), an interconnect valve (to selectively connect the low pressure and high pressure chambers), and a storage valve (to selectively connect the high pressure chamber to a gas storage system). Additional details on multistage compression and expansion, heat transfer, and liquid management can be found in the patents and applications incorporated by reference herein.

In one embodiment, the multistage compression and/or expansion system 200 operates in a compression mode as follows. Low pressure gas is drawn into vertical low pressure vessel 240a via the interstage pipe assembly 280a connection to a low pressure line. The low pressure inlet valving on the interstage pipe assembly 280a is closed and actuator 202a drives piston 210a in low pressure working vessel 214a to force liquid into the vertical low pressure vessel 240a, thereby compressing the gas to a first pressure. The compressed gas is transmitted to the vertical high pressure vessel 250a opposite the low pressure vessel 240a via the interstage pipe assembly 280a and associated valving. The high pressure inlet valving on the interstage pipe assembly 280a is closed and actuator 202b drives piston 220a in the high pressure working vessel 224a to force liquid into vertical high pressure vessel 250a, compressing the gas to a second, higher pressure. The compressed gas may then exit the high pressure vessel 250a at the interstage pipe assembly 280a connection by opening the valving to the high pressure line,

Simultaneously with the foregoing compression process, gas may be compressed in vertical low pressure vessel. 240b and vertical high pressure vessel 250b out-of-phase with the compression process in pressure vessels 240a and 240b. That is, while low pressure gas is drawn into vertical low pressure vessel 240a, actuator 202a can cause piston 210a to compress gas in vertical low pressure vessel 240b. Likewise, while low pressure gas is drawn into vertical low pressure vessel 240b, actuator 202a can cause piston 210a to compress gas in vertical low pressure vessel 240a. Further, while compressed gas is transferred from vertical low pressure vessel 240a to vertical high pressure vessel 250a, actuator 202b can cause piston 220a to compress gas in vertical high pressure vessel 250b. Similarly, while compressed gas is transferred from vertical low pressure vessel 240b to vertical high pressure vessel 250b, actuator 202b can cause piston 220a to compress gas in vertical high pressure vessel 250a. It should be noted that, because each actuator 202a, 202b is coupled to a piston at both ends, the actuators 202a, 202b can cause gas to be compressed in a low pressure vessel in one subassembly while simultaneously causing gas to be compressed in a high pressure vessel in another subassembly.

In one embodiment, the multistage compression and/or expansion system 200 operates in an expansion mode as follows. High pressure gas enters vertical high pressure vessel 250a via the interstage pipe assembly 280a connection to a high pressure line. The high pressure gas entering high pressure vessel 250a drives the liquid piston in the vessel 250a to force liquid from the vessel 250a, displacing piston 220a in the high pressure working vessel 214b and driving hydraulic actuator 202b and, e.g., an associated motor/generator. The expanded gas is transmitted from vertical high pressure vessel 250a to the low pressure vessel 240a that is opposite high pressure vessel 250a via interstage pipe assembly 280a and associated valving. The lower pressure gas then drives the liquid piston in vertical low pressure vessel 240a to force liquid from the low pressure vessel 240a, expanding the gas to a second, lower pressure and driving actuator 202a and, e.g., a motor/generator. The expanded gas may then exit vertical low pressure vessel 240a at the interstage pipe assembly 280a connection to the low pressure line.

Simultaneously with the foregoing expansion process, gas may be expanded in vertical low pressure vessel 240b and vertical high pressure vessel 250b out-of-phase with the expansion process in pressure vessels 240a and 240b. That is, while first-stage expanded gas is transferred out of vertical high pressure vessel 250a, gas can be expanded in vertical high pressure vessel 250b, forcing liquid from the vessel 250b to displace piston 220a and drive actuator 202b. Likewise, while first-stage expanded gas is transferred out of vertical high pressure vessel 250b, gas can be expanded in vertical high pressure vessel 250a, forcing liquid from the vessel 250a to displace piston 220a and drive actuator 202b. Further, while first-stage expanded gas is transferred from vertical high pressure vessel 250a to vertical low pressure vessel 240a, piston 210a can drive second-stage expanded gas out of vertical low pressure vessel 240b. Similarly, while first-stage expanded gas is transferred from vertical high pressure vessel 250b to vertical low pressure vessel 240b, piston 210a can drive second-stage expanded gas out of vertical low pressure vessel 240a. It should be noted that, because each actuator 202a, 202b is coupled to a piston at both ends, the actuators 202a, 202b can cause or allow gas to be expanded in a low pressure vessel in one subassembly while simultaneously causing or allowing gas to be expanded in a high pressure vessel another subassembly.

In one embodiment, depicted in FIG. 3 and FIG. 4 in perspective and top views, respectively, the modular multistage compression and/or expansion system 200 illustrated in FIG. 2 is a half-unit that can be fluidically coupled to another half-unit 305 via additional piping (not shown) to form a four-actuator full unit 300. The additional piping connects the interstage pipe assemblies 320a-320h of the pressure vessel arrangements on respective sides of the actuators 340a-340d, and includes a connection to atmosphere (for intake of low pressure gas during compression and/or output of low pressure gas during expansion) and a connection to a gas storage system (for output of high pressure gas during compression and/or intake of high pressure gas during expansion). Associated hydraulic motor/generator and switching equipment 350 can be shared between half-units 200, 305. Each half-unit system 200, 305 may also be coupled to one or more additional half-units or full units to build a system of any capacity to meet a desired project rating.

FIG. 5 depicts one embodiment of a modular compressor/expander vessel subassembly 500 used in the CAES system 200 of FIGS. 2-4. A full CAES unit, as shown in FIG. 3 and FIG. 4, includes four of these modular subassemblies 500. The subassembly 500 includes a horizontally aligned low pressure hydraulic working vessel 510 and a horizontally aligned high pressure hydraulic working vessel 520. Each working vessel includes a horizontally reciprocating piston within an interior of the vessel (described in further detail below). In one embodiment, the piston in each working vessel has a predetermined stroke length. Two vertically aligned low pressure vessels 530a, 530b are coupled to the low pressure working vessel 510 on opposite sides thereof, and two vertically aligned high pressure vessels 540a, 540b are coupled to the high pressure working vessel 520 on opposite sides thereof. Each low pressure vessel 530a, 530b fluidically coupled to the high pressure vessel 540a, 540b opposite thereto by an interstage piping assembly 550a, 550b (further described below) that provides a conduit for the exchange of fluid (e.g., gas) between the low pressure vessels 530a, 530b and high pressure vessels 540a, 540b as well as between the subassembly 500 and a high pressure line (e.g., compressed gas storage) and between the subassembly 500 and a low pressure line (e.g., ambient pressure).

In the configuration shown, the dimensions of the compressor/expander vessel subassembly 500 and gap between the low pressure hydraulic working vessel 510 and high pressure hydraulic working vessel 520 may be customized to suit a particular system configuration and project. Portions of the subassembly 500 may be constructed of a pressure vessel steel, such as SA 516 Grade 70 carbon steel plate.

FIG. 6 shows the low pressure vessel arrangement 600 of the compressor/expander subassembly 600 depicted in FIG. 5 (the reciprocating piston shaft and interstage connections are not shown). Of note, the arrangement 600 is configured substantially symmetrically (i.e., the left and right portions have substantially identical construction), resulting in increased modularity and reduced complexity in manufacturing and assembly. The arrangement 600 may be dimensioned suitably for a particular system configuration and project. The working vessel 510 and each of the low pressure vessels 530a, 530b may have a shell of predetermined thickness, and may be constructed of a pressure vessel steel, such as SA 516 Grade 70 carbon steel plate. The piston in the working vessel 510 may have a predetermined stroke length and outer diameter.

FIG. 7 shows the high pressure vessel arrangement 700 of the compressor/expander subassembly 500 depicted in FIG. 5 (the reciprocating piston shaft and interstage connections are not shown). Of note, the arrangement 700 is configured substantially symmetrically (i.e., the left and right portions have substantially identical construction), resulting in increased modularity and reduced complexity in manufacturing and assembly. The arrangement 700 may be dimensioned suitably for a particular system configuration and project. The working vessel 520 and each of the high pressure vessels 540a, 540b may have a shell of predetermined thickness, and may be constructed of a pressure vessel steel, such as SA 516 Grade 70 carbon steel plate. The piston in the working vessel 510 may have a predetermined stroke length and outer diameter.

FIG. 8 depicts one embodiment of a low pressure vessel arrangement 800 in which the interiors of the horizontal low pressure hydraulic working vessel 810 and one of the vertical low pressure vessels 820a, 820b are visible. Although FIG. 8 depicts the internal components of a low pressure vessel arrangement 800, it should be noted that high pressure vessel arrangements can include similar components dimensioned to fit within the high pressure vessels, and can operate in a similar fashion to the low pressure arrangement 800. Accordingly, the following description is applicable to both low pressure and high pressure vessel arrangements.

The horizontal working vessel 810 includes a horizontally reciprocating shaft 830 to which a working piston is forged or attached. The piston may be solid, or a bulbous, buoyant (e.g., hollow) piston, and may form a fluidic seal with the interior wall of the working vessel 810 using an annular sealing element that can be coupled to an outer diameter of the piston and/or an inner diameter of the interior wall of the working vessel 810. In some embodiments, the working vessel 810 has an interior diameter that nears or exceeds current technology capabilities for precision machining (e.g., greater than one meter). In these instances, the working piston can include a rolling piston seal, such as that described in U.S. Pat. No. 8,567,303, issued Oct. 29, 2013, and entitled “Compressor and/or Expander Device with Rolling Piston Seal,” the entirety of which is hereby incorporated by reference herein.

The working vessel 810 may be filled with a working fluid (e.g., a heat transfer liquid such as water), fully or partially submerging the piston. In operation, the reciprocating piston displaces water in the horizontal working vessel 810 into the vertical pressure vessels 820a, 820b, converting horizontal physical piston motion to vertical liquid piston motion at a 9-degree angle with respect to the working vessel 810 (e.g., horizontally to vertically) into the vertical pressure vessels 820a, 820b. Other angles are possible between the working vessel 810 and vertical pressure vessels 820, 820b, such as 30 degrees, 45 degrees, 60 degrees, 75 degrees, and so on. The rising and falling liquid pistons make contact with heat transfer devices 870 (e.g., thermal capacitors) disposed in the upper regions of the vertical pressure vessels 820a, 820b to transfer thermal energy efficiently between compressing or expanding gas and the liquid in one or more of the vessels 810, 820a, 820b.

As shown in FIG. 9, a vertical pressure vessel 910, such as the low pressure and high pressure vessels described herein, is coupled to a horizontal working vessel 920 by a cylindrical nozzle 915. As previously mentioned, the working vessel 920 can be filled at all times with a heat transfer liquid. When the reciprocating piston disposed in the working vessel 920 moves in the direction of the vertical pressure vessel 910, the liquid is forced into the pressure vessel 910 in an upward direction, eventually immersing all or a substantial portion of heat transfer device 950 disposed in the upper region of the pressure vessel 910. When the piston moves in the direction opposite to the pressure vessel 910, the liquid is withdrawn from the pressure vessel 910 in a downward direction. Thus, as the piston reciprocates horizontally within the working vessel 920, the liquid in the pressure vessel 910 alternates between the lower liquid level 960 and the upper liquid level 970. It is to be appreciated, however, that different lower and upper liquid levels are possible. For example, the lower and upper liquid levels 960, 970 may be lower or higher than depicted in FIG. 9, and may even be disposed fully or partially in the nozzle 915 and/or the working vessel 920. The lower and upper liquid levels 960, 970 may vary based on the shape and configuration of the vessels 910, 920 as well as the shape and configuration of the heat transfer device 950, that can partially or fully fill the vessel 910 or be disposed at any location(s) and/or elevation(s) in the vessel 910.

The reverse occurs in the vertical pressure vessel disposed on the opposite side of the working vessel 920. Namely, the liquid rises in the opposite pressure vessel as it lowers in vertical pressure vessel 910, permitting a substantially closed, constant volume liquid system in each of the high and low pressure vessel subassemblies described herein.

The heat transfer device 950 operates to transfer heat between a heat transfer liquid and gas in the vertical pressure vessel 910. For example, in a compression mode, the heat transfer device 950 can absorb heat as gas is compressed by a liquid piston in the vertical pressure vessel 910. When the liquid makes contact with the heat transfer device 950, the absorbed heat is transferred to the liquid. In an expansion mode, the reverse occurs; that is, the liquid can be initially in contact with the heat transfer device 950, transferring heat from the liquid to the device 950. As gas expands in the vertical pressure chamber 910 and the liquid piston recedes, heat is transferred from the heat transfer device 950 to the gas.

In this embodiment, the heat transfer device 950 disposed in the upper region of the vertical pressure vessel 910 may take any form suitable for transferring heat energy between a heat transfer liquid and compressed and/or expanded gas. For example, the heat transfer device may include vertical fins constructed of corrugated sheet metal. Other exemplary geometries that provide a sufficient surface area for heat transfer include plates, extrusions, foams, dense woven wire, sparse woven wire, corrugated woven wire, and combinations thereof. The heat transfer device may be constructed of one or more materials such as aluminum, stainless steel, copper alloys, carbon-loaded plastic, composites, and other polymers. Aluminum and stainless steel can be used for construction, taking into account properties such as high thermal capacity, high corrosion resistance, high manufacturability, high thermal conductivity, and cost. Examples of heat transfer devices usable in the present system may include those described in U.S. Pat. No. 8,454,321, issued Jun. 4, 2013, and entitled “Methods and Devices for Optimizing Heat Transfer within a Compression and/or Expansion Device,” and International Patent Application No. PCT/US2013/023227, filed Jan. 25, 2013, and entitled “Device for Improved Heat Transfer within a Compression and/or Expansion System,” the entireties of which are hereby incorporated by reference herein.

The heat transfer liquid may be exchanged via connections to one or more vessels in the high and low pressure subassemblies, while maintaining a substantially constant volume of liquid in the vessels. For example, a liquid management system can be fluidically coupled to the horizontal working vessel 920 and/or vertical pressure vessel 910 by one or more valves, and cause heated liquid to be withdrawn from the vessel 910 and/or 920 and exchanged with cooled liquid as gas is compressed and, in reverse, cause cooled liquid to be exchanged with heated liquid as gas is expanded. One example of a liquid management system usable with the present system for exchanging heat transfer liquid can be found in U.S. Pat. No. 8,387,375, issued Mar. 5, 2013, and entitled “Systems and Methods for Optimizing Thermal Efficiency of a Compressed Air Energy Storage System,” the entirety of which is hereby incorporated by reference herein.

FIG. 10 illustrates an interstage pipe assembly 1000 used to fluidically couple a low pressure vessel and a high pressure vessel in a compression/expansion subassembly, such as the interstage pipe assembly 550a, shown in FIG. 5, fluidically coupling low pressure vessel 530a and high pressure vessel 540a and, similarly, interstage pipe assembly 550b that fluidically couples low pressure vessel 530b and high pressure vessel 540b. Each interstage pipe assembly 1000 includes three valves 1010, 1020, and 1030. Valve 1010 toggles a fluidic connection to a high pressure line (e.g., compressed gas storage in a tank, cavern, and/or other container). Valve 1010 can be opened in a compression mode to allow compressed gas to be transferred from high pressure vessels to storage and, in an expansion mode, to allow compressed gas to be received into the high pressure vessels from storage. Valve 1020 toggles a fluidic connection to a low pressure line (e.g., ambient pressure). Valve 1020 can be opened in a compression mode to allow low pressure gas to be transferred into low pressure vessels for compression and, in an expansion mode, to allow expanded gas to be released from the low pressure vessels to ambient. Valve 1030 toggles a fluidic connection between the low pressure and high pressure to which the interstage pipe is coupled. Valve 1030 can be opened in a compression mode to allow gas compressed in a first stage to be transferred from the low pressure vessel to the high pressure vessel for second-stage compression. In an expansion mode, valve 1030 can be opened to allow gas expanded in a first stage to be transferred from the high pressure vessel to the low pressure vessel for second-stage expansion.

FIG. 11 and FIG. 12 respectively depict a top view and a side view of a modular two-actuator half-unit 11100 of a CAES system as described herein. The half-unit 1100 can include two subassemblies 1102, 1106, each of which can have substantially identical construction, with subassembly 1106 rotated 180 degrees with respect to subassembly 1102. As described herein, the subassemblies can each include a low pressure vessel arrangement 1115a, 1115b and a high pressure vessel arrangement 1125a, 1125b. Compression and/or expansion can be performed in the pressure vessels of the subassemblies 1102, 1106 using actuators 1110, 1120. Each actuator 1110, 1120 is coupled at opposite ends to hydraulic vessel piston shafts of the compression/expansion subassemblies 11102, 1106. More specifically, actuator 1110 is coupled at a first end to the piston disposed in the low pressure hydraulic working vessel 1140 of subassembly 1102 and at a second end, opposite the first end, to the piston disposed in high pressure hydraulic working vessel 1150 of a separate subassembly 1106. Further, actuator 1120 is coupled at a first end to the piston disposed in the high pressure hydraulic working vessel 1152 of subassembly 1102, and at a second end, opposite the first end, to the piston disposed in low pressure hydraulic working vessel 1142 of subassembly 1106.

FIG. 13 and FIG. 14 are top and perspective views, respectively, of three CAES system full units 1310, 1320, 1330 connected in parallel. The interstage pipe assembly of each compressor/expander subassembly is fluidically coupled to one of four low pressure lines (e.g., connection to ambient pressure gas) and one of four high pressure lines (e.g., connection to compressed gas storage) running parallel to one another and disposed above the CAES units 1310, 1320, 1330. Other piping configurations are possible; for example, some or all of the pipes may be disposed on the side of or underneath the CAES units. Further, there may be fewer low pressure lines and/or fewer high pressure lines, with additional piping and/or valving to accommodate for the reduced number of lines. Each half-unit or full-unit may be operated separately from or in parallel with one or more of the other units. Due to the modular nature of the system, various assemblies can be isolated for preventative maintenance or repair, while the overall system remains in operation, thereby providing exceptional system availability and overall system reliability.

In some embodiments, the CAES systems described herein include controller circuitry and/or software to automatically operate and/or assist in manual operation of various functions and components of the systems. For example, the present system may include sensors to detect the pressure, humidity, and temperature of liquid and/or gas in working vessels and/or pressure vessels; sensors to detect the stroke speed and position of pistons; sensors to detect valve states and the flow rate of liquid and/or gas through piping and valves; sensors relating to compressed gas storage (e.g., remaining capacity, storage pressure); and so on. The sensors can be used to determine the operating state of the system as well as to provide a feedback loop to the controller. Based on parameters set by an operator and/or properties detected by the system sensors, the system can be controlled and finely tuned. For example, the controller can operate the various components of the system (e.g., valves, actuators, etc.) to set piston velocity profiles, liquid flow rates, heat transfer rates, valve timings, and other system properties to attain a desired gas compression and/or expansion rate and efficiency.

The configuration of the system described and illustrated herein provides a number of advantages over existing systems, such as those including a stacked, vertical shaft working vessel arrangement. In general, the present system improves overall process flow dynamics, including reductions in non-pass-through volume (resulting in improved thermodynamics), and an elimination of choke points in the flow stream (resulting in higher efficiency). The highly modular design of the CAES system components allows for quick service and replacement. In general, the components are smaller and/or shorter as well as more easily accessible than with existing systems. There are few body flanges and external working vessels (e.g., pressure vessels) can be replaced without splitting the vessel body flanges. Further, the external coupling between the working vessels and the hydraulic actuator allows for a simplified disconnect and replacement of major components, and the hydraulics are exposed (not shrouded by a skirt), providing for easy access.

A fixed gantry crane can be used for assembly, thereby avoiding the need for outdoor cranes and the associated soil stabilization issues. The gantry crane may also be in service over all of the components, increasing accessibility and reducing service/assembly time. Assembly time in the field is reduced, due to the modularity and ability to assemble additional components at the factory. All vessels can be cleaned, sealed, and shipped, requiring no internal work on-site. In contrast with vertically-oriented systems, service and assembly of the horizontal CAES system is safe, as it does not require work to be performed high above ground level. All mechanical components may be placed indoors within a building having a reasonable height. Moreover, no excavating is necessary to bury hydraulics.

The horizontal configuration of the hydraulic working vessel allows for the reciprocating piston within to be horizontally oriented and needing only to seal against the working liquid, rather than against a liquid and a gas, as is the case with some existing vertically-oriented piston assemblies. Further, the piston connection and shaft are not required to carry 100% of the load, but only the load generated by each piston. The internals of the working vessels are simplified, reducing the need for frequent service, and fewer catwalks are necessary for access to the exterior of the vessels. Further, because the horizontal configuration is limited in height, there is no need account for wind/seismic loading, reducing the required wall thickness of the vessels. Other advantages of the system include a reduced coefficient of variation for the vessel performance, as there are no unique pressure chamber configurations.

Heat transfer devices are fixed in the vertical pressure vessels rather than in the working chamber, simplifying the construction and operation of the horizontal working vessels and ensuring that the heat transfer devices do not have to move with respect to or be mounted on the piston. The smaller diameter of working chambers with respect to existing systems leads to thinner walls for the same pressure and less material.

Manufacturing and assembly of the heat transfer devices is simplified, and the devices may be installed or serviced without disassembly of a substantial portion of the compression/expansion subassembly. Further, commercial, off-the-shelf heat transfer devices such as heat wheels can be used. The decoupled chamber diameters allow for tailoring of the interaction between the heat transfer device and gas. In addition, the elimination of heat transfer device shrouds and interstage fins in the present system produces a less restrictive air flow path (leading to lower cost and risk). Gas can be always in contact with heat transfer fins during compression and/or expansion, and the surface tension of the heat transfer liquid can be broken without the potential for shock associated with fins first contacting the liquid.

Common interstage pipes can be used for each subassembly, reducing length and complexity. Point loads on the working vessels are virtually eliminated, thus the need for thermal expansion bellows to deal with thermal loads may be reduced or eliminated. Further, all process valves can be commonly located for service/access. Water exchange nozzles can always be exposed to water (i.e., there are no buckets or dependence on piston position). The water exchange piping is simplified, thereby improving water management capability, and the liquid exchange connections may be conveniently located.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the invention. As such, the invention is not to be defined only by the preceding illustrative description, but rather by the claims, and all equivalents.

1. A modular compressed air energy storage system comprising a modular low pressure subsystem, the low pressure subsystem comprising:
a low pressure hydraulic vessel adapted to contain a heat transfer liquid and comprising a low pressure piston disposed therein for horizontal reciprocating movement;
first and second low pressure vessels coupled to the low pressure hydraulic vessel on opposite sides of the low pressure piston, each adapted to contain at least one of the heat transfer liquid and a gas; and
first and second heat transfer devices respectively disposed within upper regions of the first and second low pressure vessels wherein:
the low pressure piston is moveable in a first direction to displace at least some of the heat transfer liquid from the low pressure hydraulic vessel to the first low pressure vessel; and
the low pressure piston is moveable in a second direction to displace at least some of the heat transfer liquid from the low pressure hydraulic vessel to the second low pressure vessel.

2. The system of claim 1, wherein each of the first and second heat transfer devices is adapted to transfer heat energy between the gas and the heat transfer liquid by contacting a surface of the heat transfer device with the heat transfer liquid.

3. The system of claim 1, wherein the low pressure piston is moveable to alternatively compress gas in each of the first and second low pressure vessels.

4. The system of claim 1, wherein the low pressure piston is moveable to alternatively expand gas in each of the first and second low pressure vessels.

5. The system of claim 1, further comprising a modular high pressure subsystem, the high pressure subsystem comprising:
a high pressure hydraulic vessel adapted to contain a heat transfer liquid and comprising a high pressure piston disposed therein for horizontal reciprocating movement;
first and second high pressure vessels coupled to the high pressure hydraulic vessel on opposite sides of the high pressure piston, each adapted to contain at least one of the heat transfer liquid and a gas; and
third and fourth heat transfer devices respectively disposed within upper regions of the first and second high pressure vessels wherein:
the high pressure piston is moveable in a first direction to displace at least some of the heat transfer liquid from the high pressure hydraulic vessel to the first high pressure vessel;
the high pressure piston is moveable in a second direction to displace at least some of the heat transfer liquid from the high pressure hydraulic vessel to the second high pressure vessel;
the first high pressure vessel is fluidically coupled to the first low pressure vessel via a first interstage pipe; and
the second high pressure vessel is fluidically coupled to the second low pressure vessel via a second interstage pipe.

6. The system of claim 5, wherein each of the third and fourth heat transfer devices is adapted to transfer heat energy between the gas and the heat transfer liquid by contacting a surface of the heat transfer device with the heat transfer liquid.

7. The system of claim 5, wherein the high pressure piston is moveable to alternatively compress gas in each of the first and second high pressure vessels.

8. The system of claim 5, wherein the high pressure piston is moveable to alternatively expand gas in each of the first and second high pressure vessels.

9. The system of claim 5, wherein each interstage pipe comprises:
a first valve coupling a high pressure vessel and storage;
a second valve coupling a low pressure vessel and ambient; and
a third valve coupling a high pressure vessel and a low pressure vessel.

10. The system of claim 5, further comprising:
a first hydraulic actuator coupled to the low pressure piston; and
a second hydraulic actuator coupled to the high pressure piston,

11. The system of claim 10, further comprising a second low pressure subsystem and a second high pressure subsystem;
the first hydraulic actuator further coupled to a high pressure piston of the second high pressure subsystem; and
the second hydraulic actuator further coupled to a low pressure piston of the second low pressure subsystem.

12. The system of claim 11, duplicated one or more times, each system connected in parallel by low pressure and high pressure gas lines fluidically coupled to respective interstage pipes of each system.

13. The system of claim 5, wherein at least one of the low pressure subsystem and the high pressure subsystem is configured substantially symmetrically.

14. The system of claim 13, wherein both the low pressure subsystem and the high pressure subsystem are respectively configured substantially symmetrically.

15. A method for operating a modular compressed air energy storage system, the method comprising:
providing a modular low pressure subsystem, the low pressure subsystem comprising:
a low pressure hydraulic vessel adapted to contain a heat transfer liquid and comprising a low pressure piston disposed therein for horizontal reciprocating movement;
first and second low pressure vessels coupled to the low pressure hydraulic vessel on opposite sides of the low pressure piston, each adapted to contain at least one of the heat transfer liquid and a gas; and
first and second heat transfer devices respectively disposed within upper regions of the first and second low pressure vessels;
moving the low pressure piston in a first direction to displace at east some of the heat transfer liquid from the low pressure hydraulic vessel to the first low pressure vessel; and
moving the low pressure piston in a second direction to displace at least some of the heat transfer liquid from the low pressure hydraulic vessel to the second low pressure vessel.

16. The method of claim 15, further comprising transferring heat energy between the gas and the heat transfer liquid by contacting a surface of at least one of the first and second heat transfer devices with the heat transfer liquid.

17. The method of claim 15, further comprising moving the low pressure piston to alternatively compress gas in each of the first and second low pressure vessels.

18. The method of claim 15, further comprising moving the low pressure piston to alternatively expand gas in each of the first and second low pressure vessels.

19. The method of claim 15, further comprising:
providing a modular high pressure subsystem, the high pressure subsystem comprising:
a high pressure hydraulic vessel adapted to contain a heat transfer liquid and comprising a high pressure piston disposed therein for horizontal reciprocating movement;
first and second high pressure vessels coupled to the high pressure hydraulic vessel on opposite sides of the high pressure piston, each adapted to contain at least one of the heat transfer liquid and a gas, wherein the first high pressure vessel is fluidically coupled to the first low pressure vessel via a first interstage pipe, and wherein the second high pressure vessel is fluidically coupled to the second low pressure vessel via a second interstage pipe; and
third and fourth heat transfer devices respectively disposed within upper regions of the first and second high pressure vessels;
moving the high pressure piston in a first direction to displace at least some of the heat transfer liquid from the high pressure hydraulic vessel to the first high pressure vessel; and
moving the high pressure piston in a second direction to displace at least some of the heat transfer liquid from the high pressure hydraulic vessel to the second high pressure vessel.

20. The method of claim 19, further comprising transferring heat energy between the gas and the heat transfer liquid by contacting a surface of at least one of the third and fourth heat transfer devices with the heat transfer liquid.

21. The method of claim 19, further comprising moving the high pressure piston to alternatively compress gas in each of the first and second high pressure vessels.

22. The method of claim 19, further comprising moving the high pressure piston to alternatively expand gas in each of the first and second high pressure vessels.

23. The method of claim 19, further comprising:
coupling a first hydraulic actuator to the low pressure piston; and
coupling a second hydraulic actuator to the high pressure piston.

24. The method of claim 23, further comprising:
providing a second low pressure subsystem and a second high pressure subsystem;
coupling the first hydraulic actuator to a high pressure piston of the second high pressure subsystem; and
coupling the second hydraulic actuator to a low pressure piston of the second low pressure subsystem.

25. The method of claim 24, further comprising:
duplicating the modular compressed air energy storage system one or more times; and
connecting the modular compressed air energy storage systems in parallel by low pressure and high pressure gas lines fluidically coupled to the respective interstage pipes of each system.
